(19) United States
(12) Patent Application Publication
(10) Pub. No.: US 2008/0196963 A1
(43) Pub. Date: Aug. 21, 2008

(54) Method and Device For Controlling a Car

(76) Inventor: Margareta Karlsson, Vanersborg (SE)

Correspondence Address: HARNESS, DICKEY & PIERCE, P.L.C., P.O. BOX 8910, RESTON, VA, 20195, US

(21) Appl. No.: 11/597,893

(22) PCT Filed: Jun. 4, 2004
(86) PCT No.: PCT/SE2004/000869

§ 371 Date: Dec. 7, 2007

(51) Int. Cl. B60K 28/06; E05B 19/00; B60R 25/04

(52) U.S. Cl. 180/272; 340/576

(57) ABSTRACT

An alco key for a car uses the immobiliser associated with the car's ignition system. A key is used for remote control of the immobiliser of a car, said key comprising an analysis device for determining the alcohol level of a person and, arranged to transmit a signal authorizing starting the car only if the alcohol level is below a predetermined limit. The method comprises the steps of—transmitting an open signal to at least one door of the car—operating the ignition key to start the car,—detecting the alcohol level of a person and, if the level is below a predetermined limit level, transmitting an ok signal wirelessly to signal that it is ok to start the car,—starting the car only if said ok signal has been received by the immobiliser. The opening of doors can be controlled in a similar way.

### TECHNICAL FIELD

The present invention relates to a key for opening a car or for controlling the immobiliser of a car, according to the preamble of claim 1 and 2, respectively. It also relates to a method for starting a car according to the preamble of claim 3, an immobiliser for controlling the ignition system of a car according to the preamble of claim 6 and an ignition system comprising such an immobiliser. The invention also relates to computer program products according to the preambles of claims 7 and 8, respectively.

### BACKGROUND AND PRIOR ART

Alco keys for cars are used to prevent people from driving a car while under the influence of alcohol.

The person who wants to start the car breathes into an analyzing unit, which determines the alcohol level, and the system will decide on the basis of the analysis of the breath whether to let the individual start the car. Several such analyzing units are known in the art.

Generally, such a key is installed in the car as a separate module, which may even be fitted after the car is ready. This is expensive and complicated.

### OBJECT OF THE INVENTION

Thus it is an object of the present invention to provide a method and a device for preventing drunk driving that are simpler and less expensive than the prior art.

### SUMMARY OF THE INVENTION

This is achieved according to the present invention by a key for controlling the immobiliser of a car, comprising an ignition device for starting the car and an analysis device for determining the alcohol level of a person and, transmission means arranged to transmit a start signal authorizing starting the car only if the alcohol level is below a predetermined limit level.

The object can also be achieved by means of a key for opening a car, comprising a transmitting means for transmitting wirelessly to the car an open signal to open at least one door of said car, said key being characterized in that it comprises an analysis device for determining the alcohol level of a person and, in that the transmission means is arranged to transmit said open signal only if the alcohol level is below a predetermined limit level.

The object is also achieved by a method for starting a car comprising an ignition system for starting the car, said ignition system being controlled by an immobiliser, said method comprising the steps of
transmitting an open signal to open at least one door of the car
operating the ignition key to start the car, said method being characterized by the steps of
detecting the alcohol level of a person and, if the level is below a predetermined limit level, transmitting an ok signal wirelessly to the immobiliser to signal that it is ok to start the car,
starting the car only if said ok signal has been received by the immobiliser.

The alcohol level of the person may be detected before or after opening the door. If it is detected before the door is opened the door may be controlled so that it is opened only after the ok signal has been received by the car. Alternatively, the person may be allowed to open the car, but not to start it, if the alcohol level is higher than the limit level.

The object is also achieved by an immobiliser for controlling the ignition system of a car that can be started by means of an ignition device, said system being arranged to start the car when the ignition device is operated, and being characterized in that it comprises means for receiving wirelessly an indication that it is permissible to start the car and for starting the car only if such an indication has been received, and by an ignition system comprising such an immobiliser.

The object is also achieved by means of a computer program product for controlling an immobiliser arranged to control the ignition system of a car, said computer program product being arranged to, when the ignition is operated in the usual way, determining whether or not a start signal authorizing ignition has been received on a wireless connection and allowing the car to be started only if the start signal has been received.

The computer program product may also be arranged to control the locks of a car, and to determine, when the locks are operated in the usual way, whether or not an open signal authorizing opening the car has been received on a wireless connection and allowing the car to be opened only if the start signal has been received.

According to the present invention, therefore, the car's own immobilisation system (immobiliser) is used to prevent the driver from opening and/or starting the car if the driver is under the influence of alcohol. In this case, the immobiliser is controlled in such a way as to require two different ok signals before the car is allowed to start. Thus, only a software modification is needed to provide the car with an alco key. The invention, therefore, minimizes the modifications needed of the car.

In a preferred embodiment a first key is used for opening car and second key is used for determining alcohol level and activating ignition. In this way the person can be given access to the car without being allowed to start and drive the car. Preferably, the first key is used for opening the door and for activating ignition and notifying the immobiliser of its presence. The second key is used for checking the alcohol level and confirming to the car's immobiliser that the alco key is ok for starting. Thereafter, when both the starting key and the alco key have been approved, the immobiliser will approve start.

The first and second keys may be integrated in one physical unit to avoid having to handle two different units.

In an alternative embodiment the same key for opening car and for determining the blood alcohol level and for starting the car.

Usually the key used for testing the alcohol level will be equipped with a device for analyzing the person's breath to determine the alcohol level. Such a device is often called a breathalyzer. Alternatively another means of determining the alcohol level may be used.

### BRIEF DESCRIPTION OF THE DRAWINGS

FIG. 1 illustrates one embodiment of a key according to the invention.

### DETAILED DESCRIPTION OF EMBODIMENTS

In a first, preferred embodiment, the driver will in any case be allowed to open the vehicle and enter it, but will be prevented from starting the vehicle. In this case, two keys are needed: a first key for opening the car, and a second key, preferably in combination with the first key, for starting it.

A person approaching his/her car uses the first key to open the car, usually by remote control as is common in the art. The person then inserts the first key into the ignition and turns it to start the car. The car will not start until the driver's alcohol level has been checked by means of the second key and the second key has transmitted an “ok” signal to the alco key that the alcohol level is acceptable. The acceptable level will be dependent on the laws in each country. The check by means of the second key can be performed before the car is opened, after the driver has entered the car, or even after the key has been turned in the ignition. If the driver tries to start the car without having checked the alcohol level, he may be prompted to do so, for example, by a signal on a display or by a voice message. The “ok” signal may be transmitted from the second key automatically as soon as the breath has been analyzed and determined to be ok, or a button may be pressed to send a signal from the second key after the analysis.

In this case, the car's immobiliser must be provided with a software module to prevent the car from starting before the “ok” signal has been received from the second key. Even though two keys are needed in this embodiment, they can be integrated in one physical unit. Thus, effectively one key may be used that is arranged to transmit at least two different signals to the car: one open signal to open the doors and one ok signal to authorize starting the car.

In a second embodiment, the driver is not to be given access to the vehicle at all if the alcohol level is too high. In this case, only one key is needed. To open the car, the driver has to check his or her alcohol level using the key. Only if the alcohol level is acceptable will the key transmit the signal to the car to open the doors. The driver can then enter the car and start it. Alternatively, a second test may be required before the car will start.

In this case, the car must be provided with a software module that will only allow the doors to open if an “ok” signal has been received from the key to confirm that the alcohol level is acceptable. The car's immobiliser must be provided with a software module to prevent the car from starting before the “ok” signal has been received from the key. As in the previous embodiment, the “ok” signal may be transmitted automatically as soon as an analysis has shown that the alcohol level is acceptable, or a button on the key may have to be pressed for the “ok” signal to be transmitted.

In both the above embodiments, the key used to determine the alcohol level is preferably arranged to transmit an “ok” signal only if a test has been performed and the alcohol level has been determined to be acceptable. Alternatively, the key can be arranged to transmit an “ok” signal if the alcohol level has been determined to be acceptable, and a “not ok” signal if the alcohol level is too high. If a “not ok” signal is used, it could initiate a complete inhibition of the ignition.

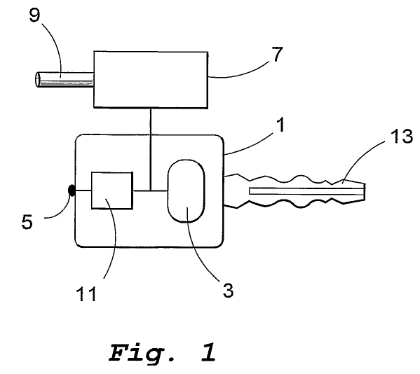

FIG. 1 shows a car key 1 that has been modified for use according to one embodiment of the invention. As is common in the art, the key comprises a button 3 that would normally be used for initiating an open signal to be transmitted to the car, and a transmitting unit 5 for transmitting the open signal. In this case, the key comprises, or is connected to, an analysis device 7 for determining the alcohol level of a person. Typically, the analysis device 7 is arranged to do so by analyzing the breath of the person breathing into the analysis device through a breathing tube 9. The result is analyzed in a processing means 11 either in the analysis device 7 or in the key 1. If the result shows that the alcohol level was below the predetermined limit, the open signal is transmitted to the car from the transmitting unit 5. In this case the open signal may be used to trigger the opening of the doors, and/or to enable the ignition of the car to be performed in the usual way, as discussed above. Optionally, the key can also comprise a mechanical key portion 13, to be used when starting the car.

The general inventive idea could also be used for other types of access control. Instead of checking the blood alcohol level another condition used to determine if the driver is to be allowed to open and/or drive the car can be verified. Such a condition could be, for example the identity of the person, which can be verified by means of a camera, finger prints, iris scans or other biometrics. The result of this verification can be used to trigger an “ok” signal (and optionally a “not ok” signal) from the second key in a similar way as described above for alcohol level.

1. A system for starting a car, the system comprising:
a first key for opening a door of the car and activating an ignition of the car and notifying an immobilizer of the car of its presence, and
a second key for checking the alchol level of a person and, only if the alchol level is below a predetermined level, confirming to the cars immobilizer that the second key is ok for starting,
wherein, when both the first key and the second key have been approved, the immobilizer will approve start of the car.

2. A system according to claim 1, wherein the confirmation as to alcohol level is transmitted wirelessly to the car's immobilizer.

3. A system according to claim1, wherein the first and second keys are integrated in one physical unit.

4. A method for starting a car, the method comprising:
by means of a first key, opening a door of the car and activating an ignition of the car and notifying an immobolizer of the car of its presence, and
by means of a second key, checking the alchol level of a person and, only if the alcohol level is below a predetermined level, confirming to the car's immobilizer that the second key is ok for starting,
wherein, when both the first key and the second key have been approved, the immobilizer will approve start of the car.
